(19) United States
(12) Patent Application Publication
(10) Pub. No.: US 2025/0102698 A1
(43) Pub. Date: Mar. 27, 2025

(54) HIGHLY EFFICIENT AND ACCURATE ANTENNA FOR HORIZONTAL DIRECTIONAL DRILLING (HDD) LOCATORS

(71) Applicant: Underground Magnetics, Inc., Johnston, IA (US)

(72) Inventor: Yuriy Khapochkin, Johnston, IA (US)

(21) Appl. No.: 18/894,944

(22) Filed: Sep. 24, 2024

Related U.S. Application Data
(60) Provisional application No. 63/585,044, filed on Sep. 25, 2023.

(51) Int. Cl. G01V 3/28; E21B 47/12; H01Q 7/00

(52) U.S. Cl. CPC G01V 3/28; E21B 47/12; H01Q 7/00

(57) ABSTRACT

A three-dimensional antenna includes a first pair of rods and at least a first pair of coils that define a first field measurement location, and a second pair of rods and at least a second pair of coils that define a second field measurement location, where the first field measurement location and the second field measurement location are at least substantially aligned with one another. The three-dimensional antenna can also include a third pair of coils, where the first pair of rods, the first pair of coils, and the third pair of coils define the first field measurement location. The three-dimensional antenna can also include switches for connecting adjacent ones of the first pair of coils and the third pair of coils in series or parallel with one another, and for connecting the first pair of coils and the third pair of coils in series or parallel with one another.

### CROSS-REFERENCE TO RELATED APPLICATIONS

The present application claims the benefit under 35 U.S.C. § 119 (e) of U.S. Provisional Application Ser. No. 63/585,044, filed Sep. 25, 2023, and titled “HIGHLY EFFICIENT AND ACCURATE ANTENNA FOR HORIZONTAL DIRECTIONAL DRILLING (HDD) LOCATORS,” which is herein incorporated by reference in its entirety.

### BACKGROUND

Directional drilling can be used to drill a tunnel in order to install underground utility lines, pipelines, cables, service conduits, and so forth.

### DRAWINGS

The Detailed Description is described with reference to the accompanying figures. The use of the same reference numbers in different instances in the description and the figures may indicate similar or identical items.

FIG. 1 is a diagrammatic illustration of a pair of rods for a three-dimensional antenna arranged at least substantially parallel to one another and spaced apart from one another, where each one of a first pair of coils and a second pair of coils is wrapped around each one of the pair of rods so that each one of the pair of rods is wrapped in two adjacent coils, and where the pair of rods, the first pair of coils, and the second pair of coils define a field measurement location at a three-dimensional point in space between the rods in accordance with example embodiments of the present disclosure.

FIG. 2 is a top view illustrating a three-dimensional antenna with a pair of rods arranged at least substantially parallel to one another and spaced apart from one another, where each one of a first pair of coils and a second pair of coils is wrapped around each one of the pair of rods so that each one of the pair of rods is wrapped in two adjacent coils, and where the pair of rods, the first pair of coils, and the second pair of coils define a field measurement location at a three-dimensional point in space between the rods in accordance with example embodiments of the present disclosure.

FIG. 3 is a perspective view illustrating a three-dimensional antenna with three orthogonal pairs of rods, with each rod having two adjacent coils and defining a field measurement location that is at least substantially the same for each one of the pairs of rods and corresponding coils in accordance with example embodiments of the present disclosure.

FIG. 4 is a diagrammatic illustration of a circuit with two pairs of coils for a three-dimensional antenna, such as the three-dimensional antennas illustrated in FIGS. 2 and 3, where all four coils of the two pairs of coils are connected in series in accordance with example embodiments of the present disclosure.

FIG. 5 is a diagrammatic illustration of a circuit with two pairs of coils for a three-dimensional antenna, such as the three-dimensional antennas illustrated in FIGS. 2 and 3, where two coils of the two pairs of coils are connected in series and two coils of the two pairs of coils are connected in parallel in accordance with example embodiments of the present disclosure.

FIG. 6 is a diagrammatic illustration of a circuit with two pairs of coils for a three-dimensional antenna, such as the three-dimensional antennas illustrated in FIGS. 2 and 3, where two coils of the two pairs of coils are connected in parallel and two coils of the two pairs of coils are connected in series in accordance with example embodiments of the present disclosure.

FIG. 7 is a diagrammatic illustration of a circuit with two pairs of coils for a three-dimensional antenna, such as the three-dimensional antennas illustrated in FIGS. 2 and 3, where all four coils of the two pairs of coils are connected in parallel in accordance with example embodiments of the present disclosure.

FIG. 8 is a diagrammatic illustration of a circuit schematic with a set of switches for two pairs of coils for a three-dimensional antenna, such as the three-dimensional antennas illustrated in FIGS. 2 and 3, in accordance with example embodiments of the present disclosure.

FIG. 9 is a chart illustrating inductance options for a set of switches for two pairs of coils for a three-dimensional antenna, such as the set of switches illustrated in FIG. 8, in accordance with example embodiments of the present disclosure.

### DETAILED DESCRIPTION

Locating systems generally include an underground transmitter (e.g., positioned inside a drill head) and an above-ground locator. The transmitter transmits data and a locating dipole signal at a specific frequency. The locator receives the data and the locating dipole signal, e.g., using a set of three (3) orthogonal antennas. Depending upon the ambient noise level and/or the locating environment, different frequencies may be used to achieve desired results, e.g., for locating accuracy, maximum operational depth, and so forth. For example, for high passive interference locations (e.g., under reinforced concrete), very low frequencies, such as frequencies below one kilohertz (1 kHz) may be used. For deep underground drilling, higher frequencies, such as frequencies up to fifty kilohertz (50 kHz) may be used. Typically, locating systems can use frequencies ranging from about three-tenths of a kilohertz (0.3 kHz) to about forty-five kilohertz (45 kHz). This provides a ratio of about one hundred and fifty to one (150:1) between the highest and lowest frequencies.

Generally, antennas for low end frequencies, e.g., less than about twenty kilohertz (<20 kHz) have relatively high inductance, e.g., between fifty and five hundred millihenry (50-500 mH), while antennas for high end frequencies have relatively low inductance, e.g., between about one and ten millihenry (1-10 mH). Currently, receiver antennas for locating systems are configured as air core antennas or ferrite rod antennas and use either a single coil or two coils in a differential configuration. These antennas have different inductances and frequency ranges as selected for either the low end frequencies or the high end frequencies discussed above. However, such antennas do not cover the whole frequency band, e.g., from 0.3 kHz to 45 kHz.

Further, when three-dimensional antennas use three separate ferrite rods, they are spatially separated such that three components of the field are measured in different points in three-dimensional space. An air core printed circuit board (PCB) antenna can be made such that three antennas intersect one another and can accurately measure three components of a magnetic field in the same point in three-dimensional space. However, in practice air core PCB antennas have low inductance (e.g., due to production costs, dimensions, etc.). For example, the inductance of air core PCB antennas is typically less than five millihenry (5 mH), and these antennas perform poorly at the lower end of the frequency range, e.g., at sub-kilohertz frequencies.

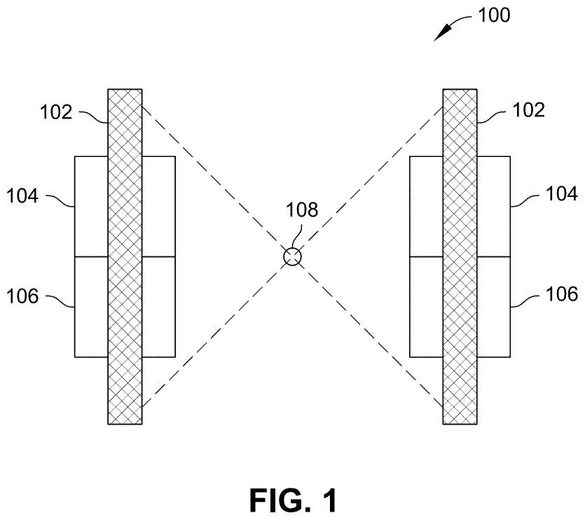

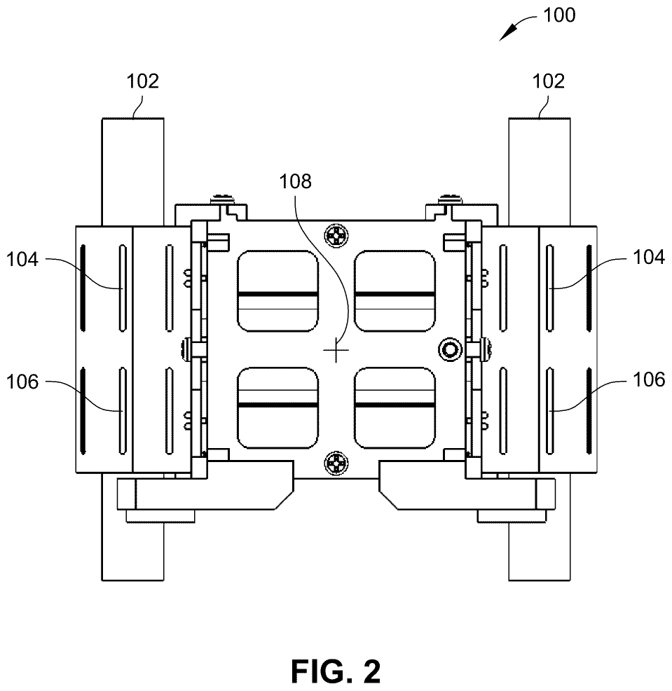

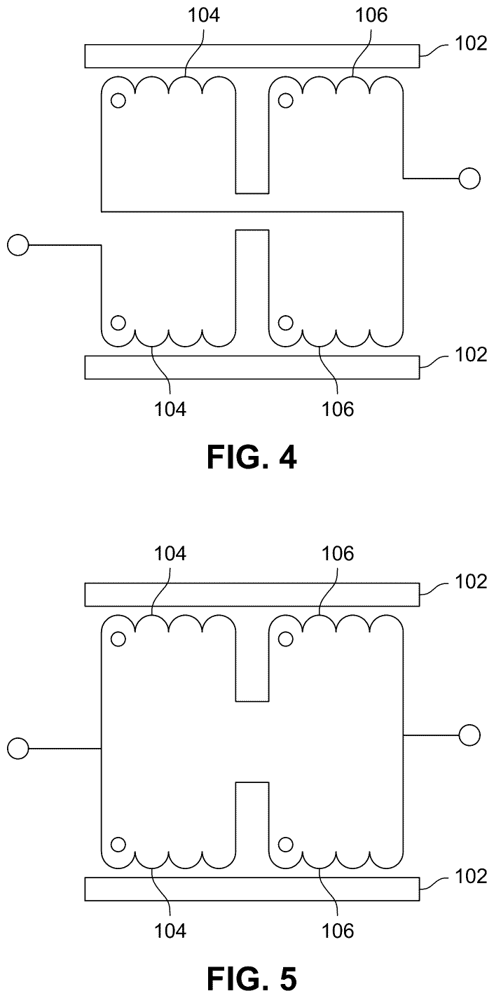

Referring generally to FIGS. 1 through 9, three-dimensional antennas 100 for locating systems, such as locating systems for horizontal directional drilling, are described. In order to provide antenna configurations across a wide frequency range, the inductance of the three-dimensional antennas 100 can be changed. Having several options for inductance allows the three-dimensional antennas 100 to be configured for particular sub-bands within a full frequency range. Further, for increased accuracy, three pairs of rods of the three-dimensional antennas 100 can measure the field in the same point in three-dimensional space. For example, to measure the field in the same point, symmetrical construction of the antenna can be used. As described in some embodiments, two ferrite rods with two coils per ferrite rod for each measured direction can be used, e.g., for a total of six (6) ferrite rods. As described, two parallel rods can be electrically combined to work as a single antenna coil. Signals from both antenna rods of a set can be added together to provide more accurate measurements of the field between two the rods.

A three-dimensional antenna 100 includes a first pair of rods 102 arranged at least substantially parallel to one another and spaced apart from one another. In some embodiments, the first pair of rods 102 can be ferrite rods. The three-dimensional antenna 100 also includes coils (e.g., a first pair of coils 104), where each one of the first pair of coils 104 is disposed of (e.g., coiled around, wrapped around) one of the first pair of rods 102. For example, each rod is wrapped with a corresponding coil. In some embodiments, the three-dimensional antenna 100 also includes additional coils (e.g., a second pair of coils 106), where each one of the second pair of coils 106 is disposed of (e.g., coiled around, wrapped around) one of the first pair of rods 102. For instance, each one of the first pair of rods 102 is also wrapped with a corresponding second coil of the second pair of coils 106. In some embodiments, the two coils wrapped around each rod are positioned adjacent to one another, e.g., as illustrated in the accompanying drawings. As described, the first pair of rods 102 and the first pair of coils 104 (and possibly the second pair of coils 106) define a first field measurement location 108 at a three-dimensional point in space. For example, the first filed measurement location 108 is centered between the first pair of rods 102.

The three-dimensional antenna 100 also includes a second pair of rods 110 arranged at least substantially parallel to one another and spaced apart from one another. In some embodiments, the second pair of rods 110 can be ferrite rods. The three-dimensional antenna 100 also includes coils (e.g., a third pair of coils 112), where each one of the third pair of coils 112 is disposed of (e.g., coiled around, wrapped around) one of the second pair of rods 110. For example, each rod is wrapped with a corresponding coil. In some embodiments, the three-dimensional antenna 100 also includes additional coils (e.g., a fourth pair of coils 114), where each one of the fourth pair of coils 114 is disposed of (e.g., coiled around, wrapped around) one of the second pair of rods 110. For instance, each one of the second pair of rods 110 is also wrapped with a corresponding second coil of the fourth pair of coils 114. In some embodiments, the two coils wrapped around each rod are positioned adjacent to one another, e.g., as illustrated in the accompanying drawings. As described, the second pair of rods 110 and the third pair of coils 112 (and possibly the fourth pair of coils 114) define a second field measurement location 116 at a three-dimensional point in space. For example, the second filed measurement location 116 is centered between the second pair of rods 110.

In some embodiments, the three-dimensional antenna 100 includes a third pair of rods 118 arranged at least substantially parallel to one another and spaced apart from one another. In some embodiments, the third pair of rods 118 can be ferrite rods. The three-dimensional antenna 100 also includes coils (e.g., a fifth pair of coils 120), where each one of the fifth pair of coils 120 is disposed of (e.g., coiled around, wrapped around) one of the third pair of rods 118. For example, each rod is wrapped with a corresponding coil. In some embodiments, the three-dimensional antenna 100 also includes additional coils (e.g., a sixth pair of coils 122), where each one of the sixth pair of coils 122 is disposed of (e.g., coiled around, wrapped around) one of the third pair of rods 118. For instance, each one of the third pair of rods 118 is also wrapped with a corresponding second coil of the sixth pair of coils 122. In some embodiments, the two coils wrapped around each rod are positioned adjacent to one another, e.g., as illustrated in the accompanying drawings. As described, the third pair of rods 118 and the fifth pair of coils 120 (and possibly the sixth pair of coils 122) define a third field measurement location 124 at a three-dimensional point in space. For example, the third filed measurement location 124 is centered between the third pair of rods 118.

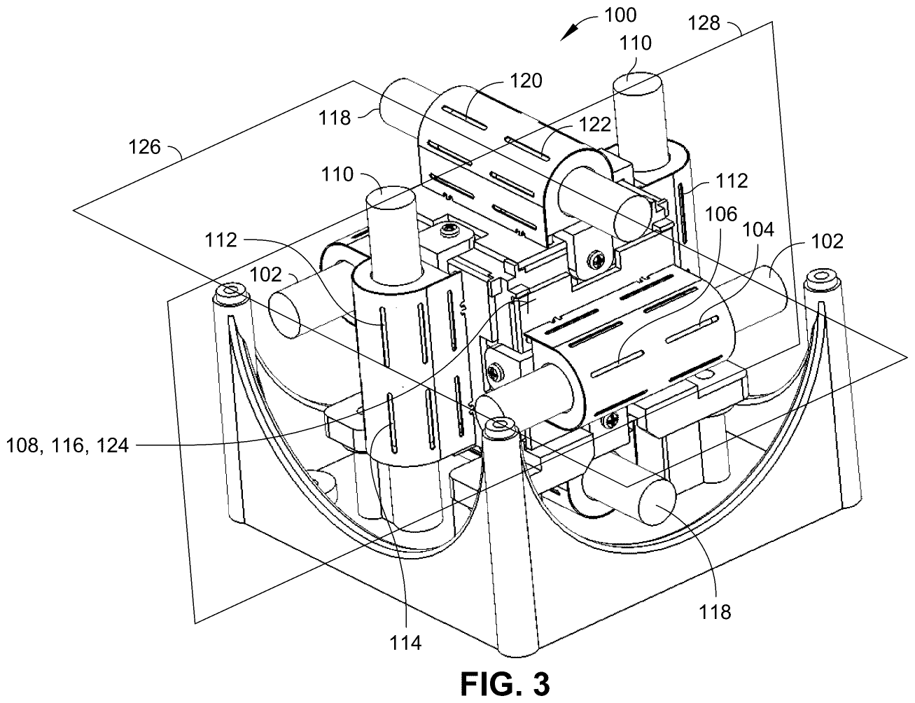

In embodiments of the disclosure, the first field measurement location 108 and the second field measurement location 116 (and possibly the third field measurement location 124) are at least substantially aligned with one another. For example, the first field measurement location 108 and the second field measurement location 116 (and possibly the third field measurement location 124) can be at least substantially the same location in three-dimensional space (e.g., as shown in FIG. 3). In other examples, the field measurement locations can be near one another but are not necessarily at the same location. As described, the first pair of rods 102 can define a first plane 126 and the second pair of rods 110 can define a second plane 128 (e.g., where each rod lays in its corresponding plane), and the first plane 126 and the second plane 128 can be at least substantially orthogonal to one another. For example, planes defined by the first pair of rods 102, the second pair of rods 110, and possibly the third pair of rods 118 may all be at least substantially orthogonal to one another.

As described, when the rods include multiple coils (e.g., first coils 104 and second coils 106, third coils 112 and fourth coils 114, fifth coils 120 and sixth coils 122), the coils can be connected to one another in various combinations of serial and parallel connections. For example, the three-dimensional antenna 100 includes a first set of switches 130 for connecting adjacent ones of the first pair of coils 104 and the second pair of coils 106 in series or parallel with one another, and for connecting the first pair of coils 104 and the second pair of coils 106 in series or parallel with one another. The three-dimensional antenna 100 can also include a second set of switches for connecting adjacent ones of the third pair of coils 112 and the fourth pair of coils 114 in series or parallel with one another, and for connecting the third pair of coils 112 and the fourth pair of coils 114 in series or parallel with one another. Further, the three-dimensional antenna 100 can include a third set of switches for connecting adjacent ones of the fifth pair of coils 120 and the sixth pair of coils 122 in series or parallel with one another, and for connecting the fifth pair of coils 120 and the sixth pair of coils 122 in series or parallel with one another. As described, for each antenna formed by the pair of rods and the first and second pairs of coils there are four possible parallel and serial combinations while keeping the antenna symmetrical.

With reference to FIG. 5, a first pair of coils 104 and a second pair of coils 106 each wrapped around a first pair of rods 102 can be connected together, e.g., using a first set of switches 130, so that all four coils of the first pair of coils 104 and the second pair of coils 106 are connected in series. In this example, the inductance of the antenna formed by the first pair of rods 102, the first pair of coils 104, and the second pair of coils 106 is sixteen times (16×) the inductance of one of the coils (when each coil has the same inductance). In the present example, an antenna configured in this manner can be used for frequencies ranging between three-tenths of a kilohertz (0.3 kHz) and two kilohertz (2.0 kHz).

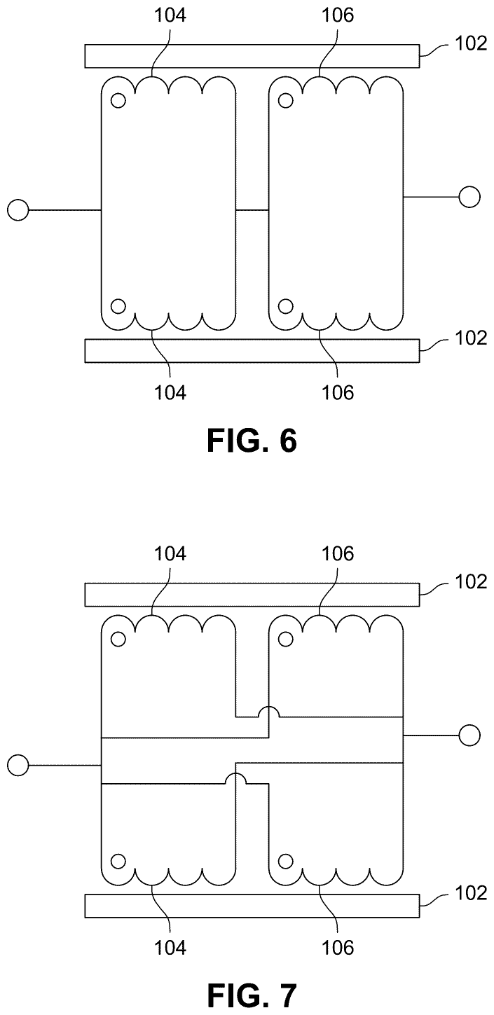

With reference to FIG. 6, a first pair of coils 104 and a second pair of coils 106 each wrapped around a first pair of rods 102 can be connected together, e.g., using a first set of switches 130, so that two coils of the first pair of coils 104 and the second pair of coils 106 are connected in series and two coils of the first pair of coils 104 and the second pair of coils 106 are connected in parallel. In this example, the inductance of the antenna formed by the first pair of rods 102, the first pair of coils 104, and the second pair of coils 106 is four times (4×) the inductance of one of the coils (when each coil has the same inductance). In the present example, an antenna configured in this manner can be used for frequencies ranging between two kilohertz (2.0 kHz) and nine kilohertz (9.0 kHz).

With reference to FIG. 7, a first pair of coils 104 and a second pair of coils 106 each wrapped around a first pair of rods 102 can be connected together, e.g., using a first set of switches 130, so that two coils of the first pair of coils 104 and the second pair of coils 106 are connected in parallel and two coils of the first pair of coils 104 and the second pair of coils 106 are connected in series. In this example, the inductance of the antenna formed by the first pair of rods 102, the first pair of coils 104, and the second pair of coils 106 is four times (4×) the inductance of one of the coils (when each coil has the same inductance). In the present example, an antenna configured in this manner can be used for frequencies ranging between two kilohertz (2.0 kHz) and nine kilohertz (9.0 kHz).

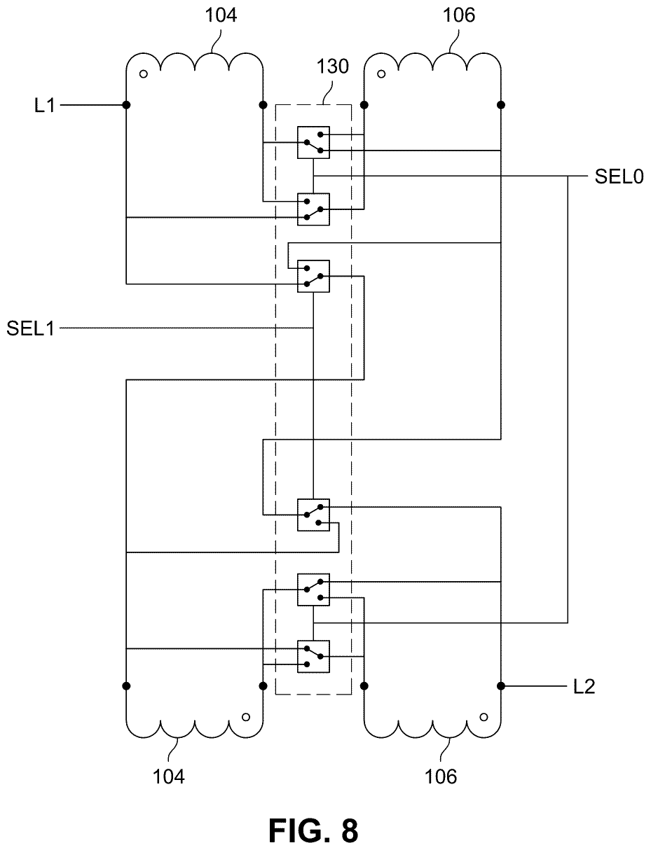

With reference to FIG. 8, a first pair of coils 104 and a second pair of coils 106 each wrapped around a first pair of rods 102 can be connected together, e.g., using a first set of switches 130, so that all four coils of the first pair of coils 104 and the second pair of coils 106 are connected in parallel. In this example, the inductance of the antenna formed by the first pair of rods 102, the first pair of coils 104, and the second pair of coils 106 is the same as the inductance of one of the coils (when each coil has the same inductance). In the present example, an antenna configured in this manner can be used for frequencies ranging between nine kilohertz (9.0 kHz) and forty-five kilohertz (45.0 kHz).

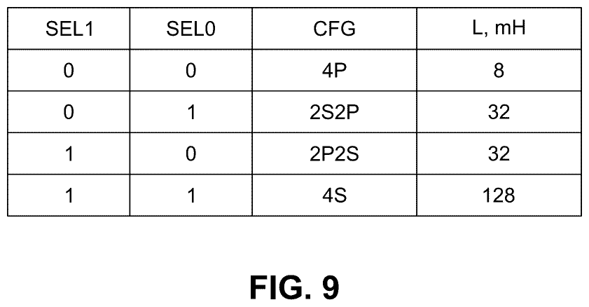

As described with reference to FIGS. 8 and 9, metal-oxide-semiconductor field-effect transistor (MOSFET) analog switches can be used to connect individual coils in the configurations described above. However, MOSFET analog switches are provided by way of example and are not meant to limit the present disclosure. In other embodiments, different switches can be used to connect the individual coils in series and parallel configurations.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A three-dimensional antenna comprising:
a first pair of rods arranged at least substantially parallel to one another and spaced apart from one another;
a first pair of coils, each one of the first pair of coils disposed of one of the first pair of rods;
a second pair of coils, each one of the second pair of coils disposed of one of the first pair of rods; the first pair of rods, the first pair of coils, and the second pair of coils defining a first field measurement location;
a second pair of rods arranged at least substantially parallel to one another and spaced apart from one another;
a third pair of coils, each one of the third pair of coils disposed of one of the second pair of rods;
a fourth pair of coils, each one of the fourth pair of coils disposed of one of the second pair of rods; the second pair of rods, the third pair of coils, and the fourth pair of coils defining a second field measurement location;
a third pair of rods arranged at least substantially parallel to one another and spaced apart from one another;
a fifth pair of coils, each one of the fifth pair of coils disposed of one of the third pair of rods; and
a sixth pair of coils, each one of the sixth pair of coils disposed of one of the third pair of rods; the third pair of rods, the fifth pair of coils, and the sixth pair of coils defining a third field measurement location, wherein the first field measurement location, the second field measurement location, and the third field measurement location are at least substantially aligned with one another.

2. The three-dimensional antenna as recited in claim 1, further comprising:
second pair of coils in series or parallel with one another, and for connecting the first pair of coils and the second pair of coils in series or parallel with one another;
a second plurality of switches for connecting adjacent ones of the third pair of coils and the fourth pair of coils in series or parallel with one another, and for connecting the third pair of coils and the fourth pair of coils in series or parallel with one another; and
a third plurality of switches for connecting adjacent ones of the fifth pair of coils and the sixth pair of coils in series or parallel with one another, and for connecting the fifth pair of coils and the sixth pair of coils in series or parallel with one another.

3. The three-dimensional antenna as recited in claim 1, wherein the first field measurement location, the second field measurement location, and the third field measurement location are at least substantially the same location.

4. The three-dimensional antenna as recited in claim 1, wherein the first pair of rods, the second pair of rods, and the third pair of rods comprise ferrite rods.

5. The three-dimensional antenna as recited in claim 1, further comprising a first plurality of switches for connecting adjacent ones of the first pair of coils and the second pair of coils in series or parallel with one another, and for connecting the first pair of coils and the second pair of coils in series or parallel with one another.

6. The three-dimensional antenna as recited in claim 5, further comprising a second plurality of switches for connecting adjacent ones of the third pair of coils and the fourth pair of coils in series or parallel with one another, and for connecting the third pair of coils and the fourth pair of coils in series or parallel with one another.

7. A three-dimensional antenna comprising:
a first pair of rods arranged at least substantially parallel to one another and spaced apart from one another;
at least a first pair of coils, each one of the first pair of coils disposed of one of the first pair of rods; the first pair of rods and the first pair of coils defining a first field measurement location;
a second pair of rods arranged at least substantially parallel to one another and spaced apart from one another;
at least a second pair of coils, each one of the second pair of coils disposed of one of the second pair of rods; the second pair of rods and the second pair of coils defining a second field measurement location;
a third pair of rods arranged at least substantially parallel to one another and spaced apart from one another; and
at least a third pair of coils, each one of the third pair of coils disposed of one of the third pair of rods; the third pair of rods and the third pair of coils defining a third field measurement location, wherein the first field measurement location, the second field measurement location, and the third field measurement location are at least substantially aligned with one another.

8. The three-dimensional antenna as recited in claim 7, further comprising:
a fourth pair of coils, each one of the fourth pair of coils disposed of one of the first pair of rods; the first pair of rods, the first pair of coils, and the fourth pair of coils defining the first field measurement location;
a fifth pair of coils, each one of the fifth pair of coils disposed of one of the second pair of rods; the second pair of rods, the second pair of coils, and the fifth pair of coils defining the second field measurement location; and
a sixth pair of coils, each one of the sixth pair of coils disposed of one of the third pair of rods; the third pair of rods, the third pair of coils, and the sixth pair of coils defining the third field measurement location.

9. The three-dimensional antenna as recited in claim 8, further comprising:
fourth pair of coils in series or parallel with one another, and for connecting the first pair of coils and the fourth pair of coils in series or parallel with one another;
a second plurality of switches for connecting adjacent ones of the second pair of coils and the fifth pair of coils in series or parallel with one another, and for connecting the second pair of coils and the fifth pair of coils in series or parallel with one another; and
a third plurality of switches for connecting adjacent ones of the third pair of coils and the sixth pair of coils in series or parallel with one another, and for connecting the third pair of coils and the sixth pair of coils in series or parallel with one another.

10. The three-dimensional antenna as recited in claim 7, wherein the first field measurement location, the second field measurement location, and the third field measurement location are at least substantially the same location.

11. The three-dimensional antenna as recited in claim 7, wherein the first pair of rods, the second pair of rods, and the third pair of rods comprise ferrite rods.

12. The three-dimensional antenna as recited in claim 7, further comprising a fourth pair of coils, each one of the fourth pair of coils disposed of one of the first pair of rods; the first pair of rods, the first pair of coils, and the fourth pair of coils defining the first field measurement location.

13. The three-dimensional antenna as recited in claim 12, further comprising a fifth pair of coils, each one of the fifth pair of coils disposed of one of the second pair of rods; the second pair of rods, the second pair of coils, and the fifth pair of coils defining the second field measurement location.

14. A three-dimensional antenna comprising:
a first pair of rods arranged at least substantially parallel to one another and spaced apart from one another;
at least a first pair of coils, each one of the first pair of coils disposed of one of the first pair of rods, the first pair of rods and the first pair of coils defining a first field measurement location;
a second pair of rods arranged at least substantially parallel to one another and spaced apart from one another; and
at least a second pair of coils, each one of the second pair of coils disposed of one of the second pair of rods, the second pair of rods and the second pair of coils defining a second field measurement location, wherein the first field measurement location and the second field measurement location are at least substantially aligned with one another.

15. The three-dimensional antenna as recited in claim 14, further comprising:
a third pair of rods arranged at least substantially parallel to one another and spaced apart from one another; and
at least a third pair of coils, each one of the third pair of coils disposed of one of the third pair of rods, the third pair of rods and the third pair of coils defining a third field measurement location, wherein the third field measurement location is at least substantially aligned with the first field measurement location and the second field measurement location.

16. The three-dimensional antenna as recited in claim 14, further comprising:
a third pair of coils, each one of the third pair of coils disposed of one of the first pair of rods; the first pair of rods, the first pair of coils, and the third pair of coils defining the first field measurement location; and
a fourth pair of coils, each one of the fourth pair of coils disposed of one of the second pair of rods; the second pair of rods, the second pair of coils, and the fourth pair of coils defining the second field measurement location.

17. The three-dimensional antenna as recited in claim 16, further comprising:
third pair of coils in series or parallel with one another, and for connecting the first pair of coils and the third pair of coils in series or parallel with one another; and
a second plurality of switches for connecting adjacent ones of the second pair of coils and the fourth pair of coils in series or parallel with one another, and for connecting the second pair of coils and the fourth pair of coils in series or parallel with one another.

18. The three-dimensional antenna as recited in claim 14, wherein the first field measurement location and the second field measurement location are at least substantially the same location.

19. The three-dimensional antenna as recited in claim 14, wherein the first pair of rods and the second pair of rods comprise ferrite rods.

20. The three-dimensional antenna as recited in claim 16, further comprising a first plurality of switches for connecting adjacent ones of the first pair of coils and the third pair of coils in series or parallel with one another, and for connecting the first pair of coils and the third pair of coils in series or parallel with one another.
